(19) United States
(12) Patent Application Publication
(10) Pub. No.: US 2003/0221995 A1
(43) Pub. Date: Dec. 4, 2003

(54) Decrease of pressure in the tube of distillation and refineries for all types of alcohol, crude oil, conversion from salt water to fresh water and all types of distillations

(76) Inventor: Hanna Albert Awad, Ajaltoun (LB)

Correspondence Address: Hanna Albert Awad, 4721 Nathan West, Sterling Heights, MI, 48310, US

(21) Appl. No.: 10/133,569

(22) Filed: May 21, 2002

(51) Int. Cl. C10G 7/00; C02F 1/04

(52) U.S. Cl. 208/347; 203/10; 208/350; 208/353

(57) ABSTRACT

Distillation is done by boiling, then cooling the vapor. If we decrease the pressure in the tube of distillation, We can have boiling at lower temperature and a rise of few degrees will boil the substance (crude oil, alcohol, salt water, etc . . . ) and turn it into vapor, then cooling by few degrees lead to the distilled substance (gas, alcohol, fresh water, etc . . . )

CIRCUMSTANCES AND DATE OF CONCEPTION: in 1998, I was thinking how to convert salt water to fresh water with a minimum of energy consumption. At high altitudes, the boiling temperature of water is less than the boiling temperature at sea level. I came to the conclusion that if we decrease the pressure above a solution, the boiling temperature of the solution will decrease. So, if we have a closed distillation and we decrease the pressure in the tube of vapor the boiling temperature will be less. Consequently, a small rise (by few degrees) of the temperature of the solution will make the solution boil and a cooling by few degrees will condensate the distilled solution.

### DESCRIPTION OF THE INVENTION

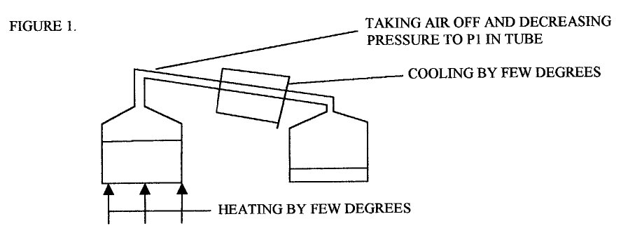

FIG. 1 if we decrease the pressure in the tube of the distillation set, which must be closed and not open to atmosphere, we can make the substance subject to distillation boil by increasing its temperature by few degrees. Then, cooling it by few degrees to get the distilled solution. This applies to salt water in order to withdraw fresh water from it. It applies to refineries and it applies to alcohol and all type of distillations.

By using the tables of pressure versus boiling temperatures of the substance subject to distillation, we can select the exact pressure needed in the tube of the distillation set. By adding to the ambient temperature a few degrees, we can select the exact corresponding pressure PI from the table of the substance corresponding to that boiling temperature.

We can decrease the energy consumed in distillation by 95% and decrease the time needed for that distillation.

PURPOSE: to decrease the energy consumed and time of a distillation.

USE: for all distillations (alcohol, crude oil, convertion of salt water into fresh water and all types of distillations)

ADVANTAGES: decrease energy consumed and time by 95%

TESTING RESULTS: we assembled FIG. 1 and it worked perfectly.

I claim:

1. The right for the design, production and sales of all distillation plants and devices, plus the production and sales of all distilled products done by this method.
